(19) United States
(12) Patent Application Publication
(10) Pub. No.: US 2025/0247381 A1
(43) Pub. Date: Jul. 31, 2025

(54) LOCAL ACCOUNT ACCESS CONDITIONED ON SSO AVAILABILITY

(71) Applicant: Dell Products L.P., Round Rock, TX (US)

(72) Inventors: Senthil Ponnuswamy, San Jose, CA (US); Gregory W. Lazar, Upton, MA (US)

(73) Assignee: Dell Products L.P., Round Rock, TX (US)

(21) Appl. No.: 18/423,664

(22) Filed: Jan. 26, 2024

(51) Int. Cl. H04L 9/40

(52) U.S. Cl. CPC H04L 63/0815; H04L 63/083

(57) ABSTRACT

A managed device may include multiple techniques to login and use resources. One example may include a single sign-on (SSO) login procedure that utilizes an identity provider that may authenticate the user. Another example may include a local account, which may allow access by the user inputting credentials, such as a login ID and a password. The managed device may condition access to the local account based on whether the identity provider is available. If the identity provider is available, then the managed device may disallow access through the local account. However, if the identity provider is unavailable, then the managed device may allow access through the local account.

### FIELD

The present disclosure relates generally to Information Handling Systems (IHSs) and relates more particularly to systems and methods for providing login by users to either a local account or a Single Sign ON (SSO) based at least on part on whether the SSO is available.

### BACKGROUND

Computing devices are typically configured to incorporate security functionality to protect such devices from unauthorized and/or malicious activity. For example, it may be desirable to prevent suspicious computer operations, such as those implemented by an illegitimate and/or unauthorized user. The availability of such security functionality, as well as the threats faced by such security functionality, can change over time.

A need exists for a more dynamic approach to protecting computing devices.

### SUMMARY

In one example embodiment, a method includes receiving a request to login to a service offered by a device; performing a check to determine whether an identity provider is available; and conditioning access to a local account of the device based on a result of performing the check.

In another example embodiment, an Information Handling System (IHS), includes: a processor; and a memory coupled to the processor, the memory having program instructions stored thereon that, upon execution by the processor, cause the processor to: provide login access to a resource by at least: a local account and a single sign-on (SSO) procedure employing communications with an identity provider over a network; receive a login request from a user, where the login request corresponds to the resource; determine whether communication with the identity provider is successfully established; and direct the user to use either the local account or the SSO procedure based at least in part on whether communication with the identity provider is successfully established.

In yet another example embodiment, a computer-readable, non-transitory memory device has program instructions stored thereon that, upon execution by a processor of an Information Handling System (IHS), cause the processor to: provide login access to a resource by at least: a local account and a single sign-on (SSO) procedure employing communications with an identity provider over a network; receive a request for the resource from a user; determine that the SSO procedure is available for the request for the resource; prompt the user to login via the SSO procedure; and disallow access to the resource via the local account in response to determining that the SSO procedure is available.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1A is an illustration of an example managed hardware device, which may condition access to a local account, according to various embodiments.

FIG. 1B is an illustration of an example managed hardware device, which may condition access to a local account, according to various embodiments.

FIG. 2 is an illustration of an example method, for allowing access by a user to a resource of a managed device, including authentication by an identity provider, according to various embodiments.

FIG. 3 is an illustration of an example method, for allowing access by a user to a resource of a managed device, including authentication by an identity provider, according to various embodiments.

FIG. 4 is an illustration of an example method, for allowing access by a user to a resource of a managed device, including access through a local account, according to various embodiments.

FIG. 5 is an illustration of an example method, for allowing access by a user to a resource of a managed device, including conditioning access to a local account, according to various embodiments.

FIG. 6 is a flowchart an example method for conditioning access to a local account, according to various embodiments.

FIG. 7 is an illustration of an example system, including cloud infrastructure, according to various embodiments.

### DETAILED DESCRIPTION

Single Sign On (SSO) may provide authentication of a single credential for accessing multiple different accounts, whether software accounts or accounts to access hardware devices. In one example use case, an administrative user may use an SSO to access multiple different Information Handling System (IHS) devices in a data center. The SSO may provide secure access by, e.g., multi-factor authentication or other login techniques. As a result, SSO may be seen as more secure than a local account, which may use only a login and password.

However, an Identity Provider (IDP), responsible for authentication in an SSO environment, may be unreachable due to a variety of reasons like network errors etc. In such cases, an Account of Last Resort (ALR), which is a local account, may be used for providing management functionality to a managed device. Since an ALR may be a weaker authentication mechanism when compared to an SSO, using the ALR may be viewed as a security risk. Furthermore, it may not be desirable for managed devices to continuously ping an IDP when the IDP is unreachable, as it may use processing power and network resources.

As noted above, use of a local account, such as an ALR, may be viewed as a security risk. Nevertheless, it may be necessary in some instances to use a local account. Continuing with the example above in which an administrative user manages multiple IHS devices in a data center, it may happen that an IHS device cannot communicate with an IDP. For instance, internal settings of the IHS might have changed or been corrupted, a network address of an IDP might have changed and not been updated in the IHS settings, there may be a network interface malfunction, or the like. In any event, the SSO may be unavailable for the administrative user, but the administrative user may require access to the IHS device to restore functionality to the IHS device. In such an instance, using a weaker local account to restore functionality to the IHS device may justify use of the weaker local account.

Various embodiments attempt to balance accessibility to devices and security by providing access to a local account conditioned on availability of SSO. For instance, when a login request is made, the IHS device may check for availability of an IDP network resource. Assuming that the IDP network resource is available, then the IHS device may make the local account unavailable, thereby allowing access only through SSO. On the other hand, should the IHS device determine that the IDP network resource is unavailable, then the IHS device may allow login through the local account.

Once the user has logged in to the local account, in some instances, the IHS device may set a timer so that local access is not accessible for an indeterminate period. For example, once the timer has expired, the IHS device may perform a fresh check for availability of the IDP network resource. If the IHS device determines that the IDP network resource has become available, then the IHS device may prompt the user to re-login using SSO and cause the local account to be unavailable. On the other hand, if the IHS device determines that the IDP network resource remains unavailable, then the IHS device may allow the user to continue to use the local account.

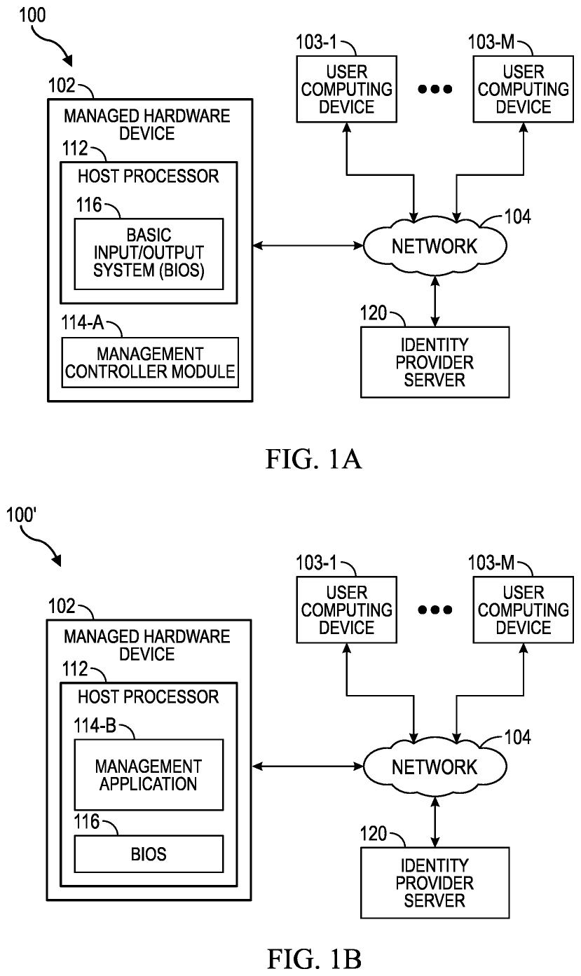

FIGS. 1A and 1B illustrate computer networks (also referred to herein as information processing systems) 100, 100′ configured to protect devices using conditioned access to a local account, in accordance with illustrative embodiments. For instance, in FIG. 1A, management controller module 114-A may be configured with logic to perform a check for communication with the identity service provider server 120 and to condition user access to a local account based on a result of the check. Similarly, in FIG. 1B, management application 114-B may be configured with logic to perform a check for communication with the identity service provider server 120 and to condition user access to a local account based on a result of the check. Both the management controller module 114-A and the management application 114-B are described in more detail below.

The computer network 100 includes a plurality of user computing devices 103-1 through 103-M, collectively referred to herein as user computing devices 103. The user computing devices 103 are coupled to a network 104, where the network 104 in this embodiment may represent a sub-network or other related portion of the larger computer network 100. Accordingly, elements 100 and 104 are both referred to herein as examples of “networks” but the latter may be a component of the former in the context of the FIGS. 1A and 1B embodiments. Also coupled to network 104 is one or more managed hardware devices 102 and one or more identity service provider servers 120, discussed below.

The managed hardware devices 102 and/or user computing devices 103 may include, for example, host devices, storage appliances and/or devices such as mobile telephones, laptop computers, tablet computers, desktop computers or other types of computing devices. Such devices are examples of what are more generally referred to herein as “processing devices.” Some of these processing devices are also generally referred to herein as “computers.” The managed hardware devices 102 and/or user computing devices 103 may include a network client that includes networking capabilities such as ethernet, Wi-Fi, etc. When the managed hardware devices 102 and/or user computing devices 103 are implemented as host devices, the host devices may illustratively include servers or other types of computers of an enterprise computer system, cloud-based computer system or other arrangement of multiple compute nodes associated with respective users.

For example, the host devices in some embodiments illustratively provide compute services such as execution of one or more applications on behalf of each of one or more users associated with respective ones of the host devices.

The user computing devices 103 in some embodiments include respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

It is to be appreciated that the term “user” in this context and elsewhere herein is intended to be broadly construed so as to encompass, for example, human, hardware, software or firmware entities (including services), as well as various combinations of such entities. Compute and/or storage services may be provided for users under a Platform-as-a-Service (PaaS) model, a Storage-as-a-Service (STaaS) model, an Infrastructure-as-a-Service (laaS) model and/or a Function-as-a-Service (FaaS) model, although it is to be appreciated that numerous other cloud infrastructure arrangements may be used. Also, illustrative embodiments may be implemented outside of the cloud infrastructure context, as in the case of a stand-alone computing and storage system implemented within a given enterprise.

As shown in FIG. 1A, an exemplary managed hardware device 102 may include a host processor 112 and a management controller module 114-A. In the example of FIG. 1A, the management controller module 114-A may be implemented as a dedicated baseboard management controller (BMC), such as the Integrated Dell Remote Access Controller (iDRAC), commercially available from Dell Technologies, or another out-of-band (OOB) controller. The host processor 112 implements a basic input/output system (BIOS) 116.

The particular arrangement of elements 112, 114-A, 116 illustrated in the managed hardware device 102 of the FIG. 1A embodiment is presented by way of example only, and alternative arrangements may be used in other embodiments. For example, the functionality associated with elements 112, 114-A, 116 in other embodiments may be combined into a single element or separated across a larger number of elements. As another example, multiple distinct processors may be used to implement different ones of elements 112, 114-A, 116 or portions thereof. At least portions of elements 112, 114-A, 116 may be implemented at least in part in the form of software that is stored in memory and executed by a processor.

In the example of FIG. 1B, a management application 114-B that executes on the host processor 112 may be implemented as a software application that executes the functions of a baseboard management controller, such as the iDRAC, referenced above. The other elements of FIG. 1B may be implemented in some embodiments in the same or a similar manner as the like-numbered elements of FIG. 1A and are not separately discussed herein.

Other managed hardware devices 102 (not shown in FIGS. 1A and 1B) may be configured in a manner similar to that shown for managed hardware device 102 in the figure.

The identity service provider server 120 may be implemented, for example, on the cloud, such as a private cloud, or on the premises of an enterprise or another entity. In some embodiments, the identity service provider server 120, or portions thereof, may be implemented as part of a host device.

The one or more managed hardware devices 102, user computing devices 103 and/or identity service provider servers 120 may be implemented on a common processing platform, or on separate processing platforms. The managed hardware devices 102 and/or user computing devices 103 may be configured to interact over the network 104 in at least some embodiments with the identity service provider server 120.

The term “processing platform” as used herein may encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location.

The network 104 may include a portion of a global computer network such as the Internet, although other types of networks may be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore includes combinations of multiple different types of networks, each including processing devices configured to communicate using internet protocol (IP) or other related communication protocols.

Also associated with the one or more managed hardware devices 102, user computing devices 103 and/or identity service provider servers 120 may be one or more input-output devices (not shown), which illustratively include keyboards, displays or other types of input-output devices in any combination. Such input-output devices may be used, for example, to support one or more user interfaces to the managed hardware devices 102 and/or the identity service provider server 120, as well as to support communications between the managed hardware devices 102, identity service provider server 120 and other related systems and devices not explicitly shown.

The one or more managed hardware devices 102, user computing devices 103 and/or identity service provider servers 120 in the FIGS. 1A and 1B embodiments may be implemented using at least one processing device. Each such processing device generally includes at least one processor and an associated memory and implements one or more functional modules for controlling certain features of the respective device.

More particularly, the one or more managed hardware devices 102, user computing devices 103 and/or identity service provider servers 120 in this embodiment each may include a processor coupled to a memory and a network interface.

The processor illustratively includes a microprocessor, a microcontroller, an application-specific integrated circuit (ASIC), a field-programmable gate array (FPGA) or other type of processing circuitry, as well as portions or combinations of such circuitry elements.

The memory illustratively includes random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including SSDs, and should therefore not be viewed as limited in any way to spinning magnetic media.

The network interface allows the one or more managed hardware devices 102, user computing devices 103 and/or identity service provider servers 120 to communicate in some embodiments over the network 104 with each other (as well as one or more other networked devices), and illustratively includes one or more conventional transceivers.

Identity service provider server 120 may provide authentication using any appropriate standard or proprietary technique. For instance, identity service provider server 120 may provide the functionality of an Identity Provider (IDP), which is a service that manages and stores user identities, authentication credentials, and related attributes. When a user attempts to access a service connected to the SSO system, the IDP may authenticate the user by verifying user credentials. Once authenticated, the IDP may generate a security token or assertion, which serves as proof of the user's identity and authentication status.

There are standards for implementing SSO, and they may involve the use of protocols such as Security Assertion Markup Language (SAML), OAuth, and OpenID Connect. SAML (Security Assertion Markup Language) is an XML-based standard for exchanging authentication and authorization data between parties, particularly between an identity provider and a service provider. OAuth (Open Authorization) is a framework that allows third-party applications to obtain limited access to a user's account without exposing the user's credentials. OAuth may be used for SSO scenarios where a user desires to grant access to their information on one site to another site. OpenlD Connect (OIDC) is an identity layer built on top of OAuth 2.0. OIDC may provide a standardized way for clients to obtain identity information about users from an IDP. Both SAML and OIDC may be used for user authentication in SSO systems.

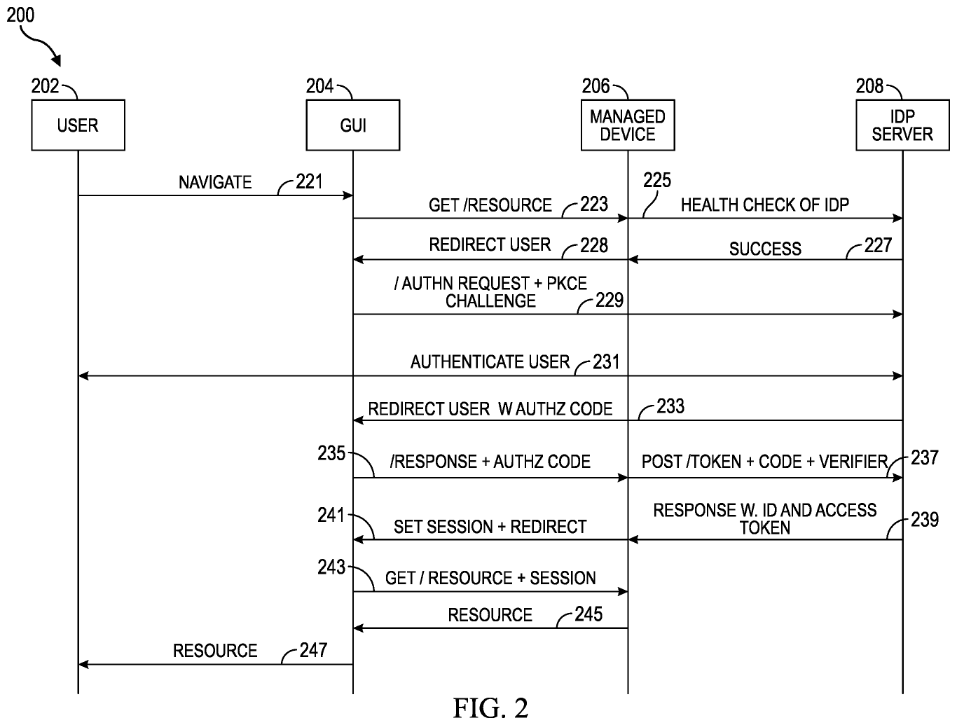

FIG. 2 is an illustration of an example method 200, for authenticating a user, according to various embodiments. In method 200, the graphical user interface (GUI) 204 may include a computer interface used by a human user 202 to enter login credentials and also interface with the managed device 206. Managed device 206 may be the same as or similar to managed hardware device 102 of FIGS. 1A, 1B. Identity provider (IDP) server 208 may be the same as or similar to identity service provider server 120 of FIGS. 1A, 1B.

Method 200 is adapted for use with OpenID Connect (OIDC). As noted above, OIDC may provide a standardized way for clients (e.g., managed device 206) to obtain information about end-users (e.g., user 202).

Although not shown in method 200, a technique for user authentication may include client registration. For instance, a process may begin with the registration of a client application (a hardware service or software service associated with managed device 206) with the IDP server 208. During registration, the client may be assigned a client ID and client secret, which are used to authenticate the client with IDP server 208.

Method 200 begins at action 221, in which the end-user 202 navigates in GUI 204 to login to managed device 206. In response to the user request at action 221, the GUI 204 sends a request message 223 to managed device 206. Managed device 206 then sends a health check message 225 to IDP server 208.

Health check message 225 may conform to any of a variety of formats. For instance, in one example, if IDP server 208 provides for a specific health check service, then health check message 225 may conform to that service. Additionally or alternatively, health check message 225 may include a telnet request, which may be a ping request to a particular port on the IDP server 208. The ping request may be performed to elicit a short response from the IDP server 208 to verify that communication between the managed device 206 and the IDP server 208 is functional. In yet another example, the health check message 225 may include a dummy authentication request, such as would be transmitted by the GUI 204. A timeout with no response to the ping request or the dummy authentication request may indicate a lack of success. However, a response to the ping request for the dummy authentication request may indicate that communications may be established. The scope of implementations is not limited to any particular format for health check message 225, as long as health check message 225 includes one or more messages configured to determine whether successful communication may be established between managed device 206 and IDP server 208.

Method 200 assumes a success, and IDP server 208 may send a success message 227 to managed device 206. Upon receipt of the success message 227, the managed device 206 determines that the communication link between the managed device 206 and the IDP server 208 is functional.

Following the determination based on receiving success message 227, method 200 may continue to authenticate the user 202 and to provide the requested resource to the user 202. The requested resource may include, e.g., any type of access to a hardware or software service at managed device 206. In one particular example, the resource may include an interface that provides the user 202 with the ability to perform administrative functions on the managed device 206. However, the scope of implementations may include any appropriate resource.

The actions associated with messages 228-243 represent one possible OIDC flow. However, the scope of implementations may include any appropriate OIDC flow.

The managed device 206 initiates an authentication request by redirecting the user to the IDP server 208 at message 228 and at message 229. The IDP server 208 authenticates the user 202 using its authentication mechanisms. Message 231 may represent a multitude of messages, such as the user submitting a username and password, multi factor authentication, or other authentication methods between the user 202 and the IDP server 208.

After successful authentication, the IDP server 208 may issue an authentication code to the managed device 206. This is shown at message 233. The code allows the managed device 206 to request an identity token and an access token.

The managed device 206 makes a token request (messages 235, 237) to the IDP server 208, presenting the authorization code received at message 233. In return, the managed device 206 receives an identity token and an access token at message 239.

The identity token may be a JavaScript Object Notation (JSON) Web token containing information about the user 202, such as a unique identifier and authentication time. The managed device 206 may use the ID token to obtain information about the user. The access token may be used by the managed device 206 to access protected resources on behalf of the user 202. The access token may also be used to request additional user information (if appropriate).

Messages 241 and 243 include the managed device 206 using the authorization token to get the resource, and at messages 245, 247, the managed device 206 provides the resource to the end-user 202.

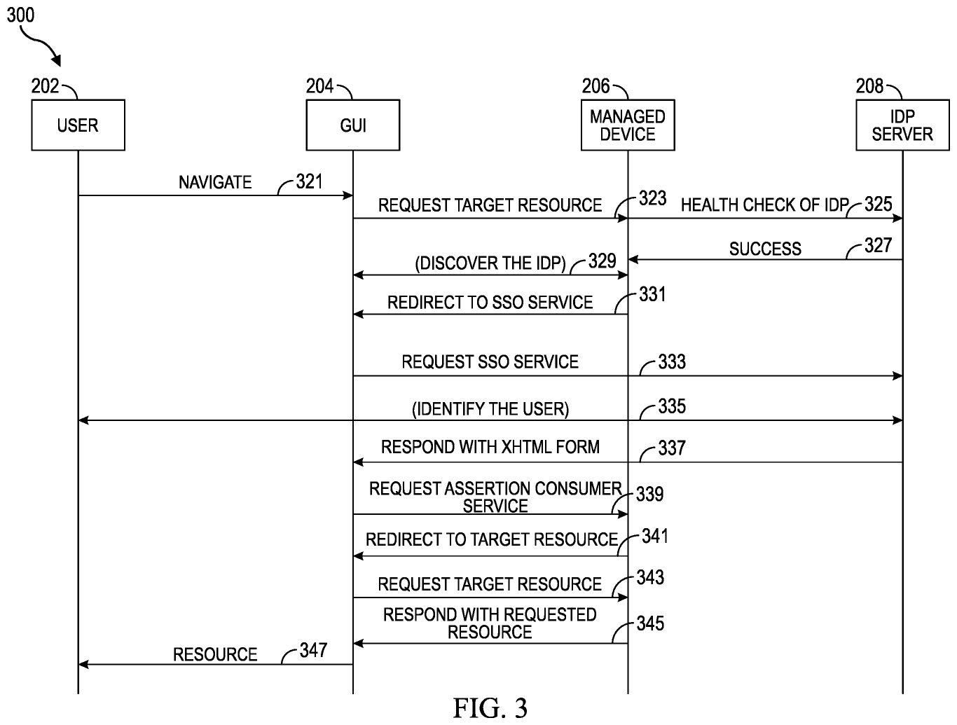

FIG. 3 is an illustration of an example method 300, for authenticating a user, according to various embodiments. In method 300, the graphical user interface (GUI) 204 may be a computer interface used by a human user 202 to enter login credentials and also interface with the managed device 206. Managed device 206 may be the same as or similar to managed hardware device 102 of FIGS. 1A, 1B. Identity provider (IDP) server 208 may be the same as or similar to identity service provider server 120 of FIGS. 1A, 1B.

Method 300 is adapted for use with SAML. However, it is noted, that the scope of implementations is not limited to any identity provider or technique for verifying a user.

At messages 321 and 323, the user 202 navigates the GUI 204 to request access to a resource. The resource may be the same type of resource or a different type of resource as was discussed above with respect to method 200.

The health check at messages 325, 327 may be the same as or similar to the health check discussed above with respect to method 200. Method 300 assumes that the health check determines that successful communication may be established between managed device 206 and IDP server 208.

Message 329 represents the managed device 206 determining a particular IDP to use. For instance, there may be a variety of IDPs to choose from, and the managed device 206 may support verification by one or more of those IDPs.

The managed device 206 generates a SAML authentication request and redirects the GUI 204 to the IDP server 208 at messages 331, 333. The request may include details, such as the identity or network address of the IDP server 208, a unique request identifier, and a desired level of authentication.

Message 335 may represent one or multiple messages in which the user provides information to be identified by the IDP server 208. For instance, the IDP server 208 may prompt the user 202 to authenticate, where the authentication may include entering a username and password, multi-factor authentication, or other appropriate authentication measures.

Upon successful authentication, the IDP server 208 may generate a SAML assertion, which may contain information about the user 202, such as identity, attributes, and an indication that the user has been authenticated. The IDP server 208 may send the SAML assertion to the GUI 204 at action 337. The assertion may be embedded within a SAML response, such as an XML formatted document.

At message 339, the GUI 204 is redirected back to the managed device 206 with the assertion. The managed device 206 now has the assertion, which includes information to establish the user's identity.

The managed device 206 verifies the authenticity of the assertion. Verifying the authenticity of the assertion may include checking a digital signature of the assertion, ensuring the assertion comes from a trusted IDP server, and confirming that the assertion has not expired. Upon successful verification of the assertion, the managed device 206 grants the user access to the requested resource, using messages 341-347. The user has now been authenticated and can interact with the managed device 206.

Of course, method 300 illustrates only one example flow for SAML, and the scope of implementations may include any appropriate flow, whether for SAML or other protocol.

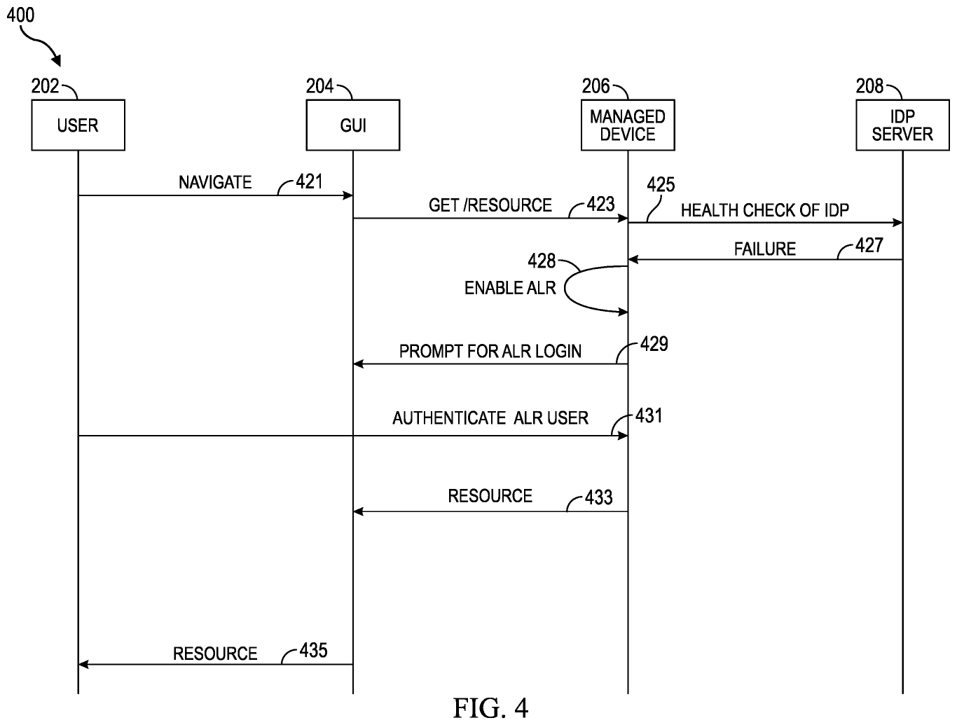

FIG. 4 is an illustration of example method 400, for authenticating the user, according to various embodiments. In method 400, the graphical user interface (GUI) 204 may be a computer interface used by a human user 202 to enter login credentials and also interface with the managed device 206. Managed device 206 may be the same as or similar to managed hardware device 102 of FIGS. 1A, 1B. Identity provider (IDP) server 208 may be the same as or similar to identity service provider server 120 of FIGS. 1A, 1B.

Method 400 illustrates what happens when the health check determines that there is a failure. Method 400 may be adapted for use with any protocol, such as OIDC, SAML, or the like.

At message 421, the user 202 attempts to access the resource using GUI 204. GUI 204 requests the resource from managed device 206 at message 423. Message 425 represents a health check, and health check 425 may be the same as or similar to the health checks discussed above with respect to methods 200 and 300. However, health check 425 identifies a failure. In this example, a failure may indicate that successful communication may not be established between managed device 206 and IDP server 208.

In some instances, a failure may include no message 427, as a lack of a response from IDP server 208 may indicate a failure. However, in other implementations, message 427 may be transmitted and received.

In response to the health check failure, the managed device 206 may determine to enable login via a local account or account of last resort (ALR) at action 428. Accordingly, the managed device 206 may prompt the user 202, via the GUI 204, for local account login credentials. At message 431, the user returns requested login credentials to the managed device 206, via the GUI 204. The managed device 206 may include local account login functionality.

For instance, the managed device 206 may be configured to include a management controller module (e.g., item 114-A) and/or a management application (item 114-B), which administers the health check, determines whether the health check is a success or a failure, and determines whether to allow access to the local account. Furthermore, the management controller module and/or the management application may administer login, such as by verifying any entered credentials.

At messages 433-435, the managed device 206 has verified the user and provides access to the resource.

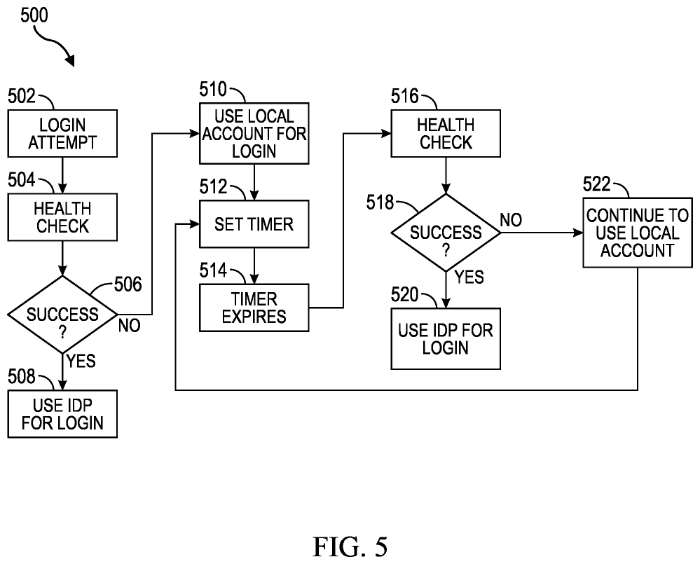

FIG. 5 is an illustration of an example method 500, for providing a requested resource to a user, according to various embodiments. Method 500 may be performed by, e.g., a management controller module (e.g., item 114-A) and/or a management application (item 114-B) associated with a managed device (e.g., item 206).

At action 502, the management controller module and/or management application receives a login attempt and, in response, performs a health check at action 504. Examples are described above with respect to signals 221-225, 321-325, and 421-425 of FIGS. 2-4.

At action 506, the management controller and/or management application determines whether the health check is a success or a failure. If the health check indicates a success, then in response the management controller and/or management application disallows use of a local account and, instead, only allows access through the IDP. Methods 200 and 300 show examples of using an IDP (IDP server 208) for SSO login at action 508.

Success at action 506 may be accompanied by disallowing use of the local account. For instance, the management controller and/or management application may change an internal setting or otherwise indicate that the local account is unavailable, thereby internally disabling use of the local account. Furthermore, success at action 506 may further include denying access to the user should the user attempt to enter local account credentials, prompting the user explicitly that the local account is unavailable, or other appropriate measures.

In the present example, the local account may include fewer factors for authentication than would SSO using the IDP. For instance, the local account may provide access via a login identification and password. By contrast, the IDP may authenticate using additional factors, such as email confirmation, email codes, text message codes, text message confirmation, or other appropriate factors.

If the management controller and/or management application determines that the health check is a failure, then the management controller and/or management application conditionally allows use of the local account for login at action 510. An example of conditionally allowing use of the local account is illustrated at FIG. 4 and messages 428-435.

The management controller and/or management application may then set a timer at action 512. The timer may be set to any appropriate time period, such as a set number of minutes or hours. However, it is within the scope of implementations for a given enterprise to determine a timer setting to balance security and access.

During the time period defined by the timer setting, the user (e.g., user 202) may access the resource from the managed device. However, the timer expires at action 514. In response to the timer expiring, the management controller and/or management application may then perform a fresh health check at action 516. The health check at action 516 may be the same as or similar to the health checks discussed above with respect to signals 225, 325, and 425.

If the management controller and/or management application determines that the health check is a success at action 518, then the management controller and/or management application may then disallow access to the local account and instead prompt the user to login using the IDP at action 520. In some embodiments, the managed device 206 may save the state of the resource being used by the user to allow the user to pick up where the user left off after logging in via the IDP.

However, if the management controller and/or management application determines that the health check is a failure at action 518, then the management controller and/or management application may continue to conditionally allow the local account to be used for login at action 522. In one implementation, action 522 may include forcing the user to re-enter local account credentials or may include simply allowing the user to continue accessing the resource uninterrupted. Assuming that the health check is a failure at action 518, then the management controller and/or management application may set the timer once again at action 512, perform a health check at action 516 and repeat as many loops as is appropriate.

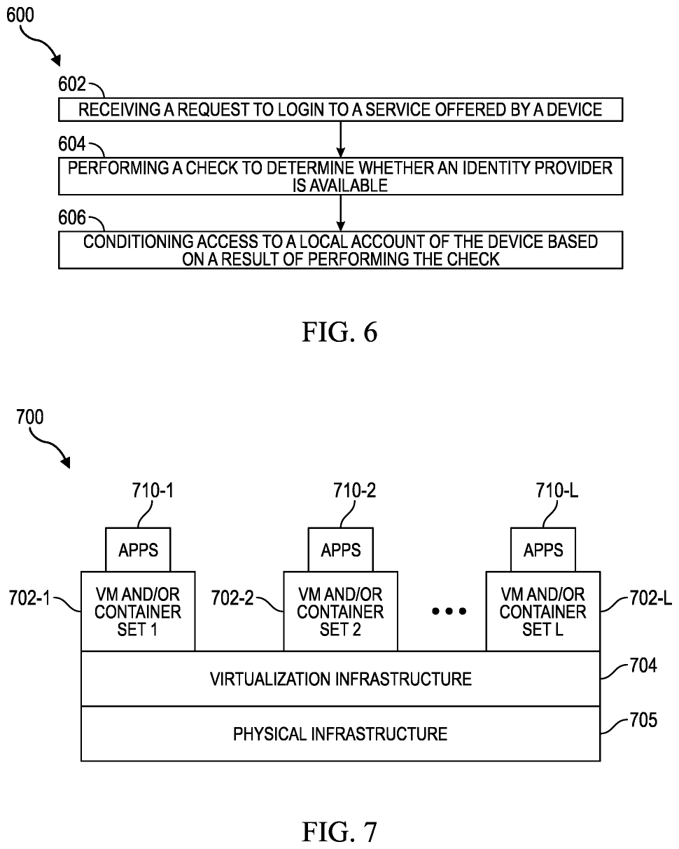

FIG. 6 is an illustration of an example method 600, for conditioning login access, according to various embodiments. Method 600 is presented from the perspective of a management controller and/or management application, such as either one or both of items 114-A and 114-B of FIG. 1.

Method 600 may be performed by a processor reading and executing instructions from a computer-readable memory. For instance, one or more processors at a management controller or host device may execute computer-readable instructions to provide the functionality of method 600.

At action 602, the management controller and/or management application receives a request to login to a service offered by a device. For example, a user (user 202) may generate a request, via an interface (e.g., GUI 204) to access a resource or service offered by a managed device (e.g., managed device 206 or 102). Examples are discussed above with respect to signals 221, 223, 321, 323, and 421, 423 of The FIGS. 2-4.

Examples of resources may include use of hardware services or use of software services. In one example, a user having enhanced permissions (e.g., an administrative user) may desire to perform sensitive operations on the managed device. For instance, a user may desire to make configuration changes, add software or firmware, remove software or firmware, or other sensitive actions. For instance, the level of access that the user may request may be generally considered a security vulnerability. However, the scope of implementations is not limited to logins by administrative users, as the conditioned access described herein may be adapted for use by users having lesser permissions.

At action 604, the management controller and/or management application performs a check to determine whether an IDP is available. For instance, examples of checks are described above with respect to actions 225 and 227, 325 and 327, and 425 and 427 of FIGS. 2-4.

At action 606, the management controller and/or management application conditions access to a local account of the device based on a result of performing the check. For example, if the managed device has successful communications with the IDP, then the management controller and/or management application may determine to make the local account login unavailable, thereby providing the user no other choice but to use the IDP. Put another way, the default security status of the management controller and/or management application made be to deny use of local account login unless the IDP is unavailable.

In another instance, at action 606, the management controller and/or management application determines that the IDP is unavailable. Unavailability may be caused by any of a variety of factors. For instance, there may be a network failure at the IDP or at a data center hosting the managed device, a hardware or software failure of the managed device, a network failure somewhere between the managed device data center and the IDP, a corrupted or changed setting at the managed device, and the like. In such an instance, the management controller and/or management application may allow access to the local account for login and access to the service or resource.

Examples of action 606 are described above with respect to signals 227-247 of FIG. 2, signals 327-347 of FIG. 3, and 427-435 of FIG. 4.

The scope of implementations is not limited to the actions shown in FIG. 6. Rather, various embodiments may add, omit, rearrange, or modify one or more actions. For instance, as described above with respect to FIG. 5, when the management controller and/or management application allows access to the local account for login, then the management controller and/or management application may set a timer and perform further health checks as appropriate.

Various embodiments may provide one or more potential advantages over other techniques. For instance, the techniques described above with respect to FIGS. 2-6 may provide greater security to a computer system than would a computer system that allows access to a local account at all times. For instance, as noted above, the local account may be seen as a security risk because it may have less stringent requirements for verification than would an SSO login. Therefore, embodiments described herein that condition access to the local account may direct users to the more stringent verification provided by SSO except for cases in which an IDP is unavailable. It is expected during normal operation that an IDP would be available; therefore, instances in which the local account may be available would generally be expected to be a minority of use cases.

FIG. 7 shows an example processing platform comprising cloud infrastructure 700. The cloud infrastructure 700 includes a combination of physical and virtual processing resources that may be utilized to implement at least a portion of the information processing system 100. The cloud infrastructure 700 includes multiple virtual machines (VMs) and/or container sets 702-1, 702-2, . . . 702-L implemented using virtualization infrastructure 704. The virtualization infrastructure 704 runs on physical infrastructure 705, and illustratively includes one or more hypervisors and/or operating system level virtualization infrastructure. The operating system level virtualization infrastructure illustratively includes kernel control groups of a Linux operating system or other type of operating system.

The GUI 204 (FIGS. 2-4) may be implemented in any appropriate manner, such as by software running on physical infrastructure 705 or applications 710. The resources requested by a user (e.g., user 202 of FIGS. 2-4) may include services associated with the physical infrastructure 705, the virtualization infrastructure 704, VM and/or containers 702, or applications 710. The functionality of the management controller 114-A or the management application 114-B as discussed at FIGS. 2-6 may be implemented in any appropriate manner and may be implemented virtually or otherwise. Furthermore, the IDP server 208 may include verification resources that are implemented virtually or otherwise.

The cloud infrastructure 700 further includes sets of applications 710-1, 710-2, . . . 710-L running on respective ones of the VMs/container sets 702-1, 702-2, . . . 702-L under the control of the virtualization infrastructure 704. The VMs/container sets 702 may include respective VMs, respective sets of one or more containers, or respective sets of one or more containers running in VMs.

In some implementations of the FIG. 7 embodiment, the VMs/container sets 702 include respective VMs implemented using virtualization infrastructure 704 that includes at least one hypervisor.

An example of a hypervisor platform that may be used to implement a hypervisor within the virtualization infrastructure 704 is the VMware® vSphere® which may have an associated virtual infrastructure management system such as the VMware® vCenter™. The underlying physical machines may include one or more distributed processing platforms that include one or more storage systems.

In other implementations of the FIG. 7 embodiment, the VMs/container sets 702 include respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

Although the invention(s) is/are described herein with reference to specific embodiments, various modifications and changes may be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method comprising:
receiving a request to login to a service offered by a computing device;
performing a check to determine whether an identity provider is available; and
conditioning access to a local account of the computing device based on a result of performing the check.

2. The method of claim 1, wherein the check comprises:
sending a telnet request to a port on a server of the identity provider.

3. The method of claim 1, wherein the check comprises:
sending an authentication request to the identity provider.

4. The method of claim 1, wherein conditioning access to the local account of the computing device comprises:
providing a prompt on a graphical user interface (GUI), associated with the computing device, the prompt indicating to a user to login using the local account, wherein providing the prompt is performed in response to the check indicating that the identity provider is not available.

5. The method of claim 1, wherein conditioning access to the local account of the computing device comprises:
prohibiting access to the local account of the computing device in response to the check indicating that the identity provider is available.

6. The method of claim 1, further comprising:
determining, based on the check, that the identity provider is not available;
providing a prompt to a user to login by the local account; and
providing the service to the user after successful login to the local account.

7. The method of claim 6, further comprising:
setting a timer in response to successful login to the local account;
in response to the timer expiring, performing a second check to determine whether the identity provider is available; and
either allowing the user to continue using the local account or prohibiting access to the local account based on a result of the second check.

8. An Information Handling System (IHS), comprising:
a processor; and
a memory coupled to the processor, the memory having program instructions stored thereon that, upon execution by the processor, cause the processor to:
provide login access to a resource by at least: a local account and a single sign-on (SSO) procedure employing communications with an identity provider over a network;
receive a login request from a user, where the login request corresponds to the resource;
determine whether communication with the identity provider is successfully established; and
direct the user to use either the local account or the SSO procedure based at least in part on whether communication with the identity provider is successfully established.

9. The IHS of claim 8, wherein the program instructions to cause the processor to direct the user includes program instructions to cause the processor to:
prompt the user to employ the SSO procedure in response to determining that the communication with the identity provider is successfully established.

10. The IHS of claim 9, further comprising program instructions to:
allow access to the resource via the SSO procedure, wherein the resource includes administrative rights to change settings associated with the IHS.

11. The IHS of claim 8, wherein the program instructions to cause the processor to direct the user includes program instructions to cause the processor to:
prompt the user to employ the local account in response to determining that the communication with the identity provider is not successfully established.

12. The IHS of claim 11, further comprising program instructions to:
allow access to the resource via the local account, wherein the resource includes administrative rights to change settings associated with the IHS.

13. The IHS of claim 11, further comprising instructions to cause the processor to:
set a timer in response to login via the local account;
determine, again, whether communication with the identity provider is successfully established; and
block access to the resource via the local account in response to determining that communication with the identity provider is successfully established.

14. The IHS of claim 8, wherein the processor is included within a baseboard management controller (BMC) of the IHS.

15. A computer-readable, non-transitory memory device having program instructions stored thereon that, upon execution by a processor of an Information Handling System (IHS), cause the processor to:
provide login access to a resource by at least: a local account and a single sign-on (SSO) procedure employing communications with an identity provider over a network;
receive a request for the resource from a user;
determine that the SSO procedure is available for the request for the resource;
prompt the user to login via the SSO procedure; and
disallow access to the resource via the local account in response to determining that the SSO procedure is available.

16. The computer-readable, non-transitory memory device of claim 15, wherein the program instructions to cause the processor to provide login access to the resource comprises program instructions to cause the processor to:
provide administrative access rights to the IHS.

17. The computer-readable, non-transitory memory device of claim 15, wherein the program instructions to cause the processor to determine that the SSO procedure is available comprises program instructions to cause the processor to:
send a telnet request to a port on a server of an identity provider associated with the SSO procedure.

18. The computer-readable, non-transitory memory device of claim 15, wherein the program instructions to cause the processor to determine that the SSO procedure is available comprises program instructions to cause the processor to:
send an authentication request to an identity provider associated with the SSO procedure.

19. The computer-readable, non-transitory memory device of claim 15, further comprising program instructions to cause the processor to:
provide the resource to the user in response to the user being authenticated via the SSO procedure.

20. The computer-readable, non-transitory memory device of claim 15, wherein the local account includes fewer factors for login than does the SSO procedure.
